(19) United States
(12) Patent Application Publication
(10) Pub. No.: US 2012/0230660 A1
(43) Pub. Date: Sep. 13, 2012

(54) METHOD AND DEVICE FOR GENERATING A HEATING MEDIUM

(75) Inventors: Itaru Sotome, Tsukuba-shi (JP); Seiichiro Isobe, Tsukuba-shi (JP); Yukio Ogasawara, Hokuto-shi (JP); Yositaka Nadachi, Setagaya-ku (JP)

(73) Assignees: Incorporated Administrative Agency National Agriculture and Food Research Organization, Tsukuba-shi (JP); Umeda Jimusho Ltd., Tokyo (JP); Taiyo Seisakusho Co., Ltd., Hokuto-shi (JP)

(21) Appl. No.: 13/510,160

(22) PCT Filed: Nov. 16, 2010
(86) PCT No.: PCT/JP2010/070384

§ 371 Date: May 16, 2012

(30) Foreign Application Priority Data
Nov. 17, 2009 (JP) 2009-261759

(51) Int. Cl. F22B 1/28; F22G 1/10; A47J 27/16; F22B 27/04

(52) U.S. Cl. 392/399; 392/400; 122/479.1; 219/401

(57) ABSTRACT

Provided are a method and device for generating a steam heating medium, the method involving generating, from a nozzle, Aqua-gas or low-temperature superheated steam that is a steam heating medium by operating an electrothermal-type generator or a steam-type generator. The method comprises the step of generating Aqua-gas by increasing a water supply amount in such a manner that an internal nozzle pressure takes on a constant value exceeding a saturated water vapor pressure of water at each internal nozzle pressure set temperature; or generating low-temperature superheated steam by reducing the water supply amount in such a manner that the internal nozzle pressure does not exceed the saturated water vapor pressure of water at each internal nozzle pressure set temperature, in a relational expression relating to a flow rate of water vapor sprayed from the nozzle, and given by Expression 1 or Expression 2, as prescribed in the present invention.

### TECHNICAL FIELD

The present invention relates to a method and device for generating a heating medium, that enable high-quality foodstuff heating processing with high heating efficiency. More specifically, the present invention relates to a method and device for generating Aqua-gas by heat exchange using electric heating and steam, as an alternative to a heating system relying on a plate heater that is an Aqua-gas generation portion built into conventional Aqua-gas heating devices. The method and device for generating Aqua-gas of the present invention provides a novel technology and novel products relating to Aqua-gas, that can be used by being built into conventional heating devices, and that can be used, in addition, in the form of an independent Aqua-gas generation device through introduction of Aqua-gas in conventional-type food heating equipment. In the present description, and as a characterizing feature of the present invention, Aqua-gas is defined as normal-pressure superheated steam that contains high-temperature water microdroplets.

### BACKGROUND ART

Superheated steam has received attention in recent years as a heating medium in food processing. Active research is being conducted on applications for heat cooking, drying, baking, sterilization and so forth. The inventors had developed a system in which, unlike in conventional superheated steam ovens, water heated at a hundred and several tens of degrees, under high pressure, is atomized into a heating chamber, to generate as a result normal-pressure superheated steam that contains high-temperature water microdroplets, such that food processing is carried out using the normal-pressure superheated steam containing high-temperature water microdroplets. The characteristics of the system and associated experimental examples in food processing have also been reported in academic journals.

The inventors have elucidated stable generation conditions of Aqua-gas, on the basis of the internal state of the pressurized hot water that is supplied, and have reported the development of a system that allows generating continuously various types of heating medium, through adjustment of the elucidated control factors. On the basis of the obtained results, the inventors have found that Aqua-gas systems are effective not only for efficient blanching of agricultural products, but also in numerous instances of food processing.

Concerning the structure and so forth of a device in conventional Aqua-gas-related technologies, the inventors had developed, and filed for a patent for, a novel method and device for generating a heating medium through boiling of water under high pressure and mixing and atomization, from a nozzle, of high-temperature water microdroplets and superheated steam, as a high-quality cooking and food processing system to which there is applied a superheated steam heating technique (Patent Document 1). The inventors had also filed for a patent for a method and device for generating, other than the abovementioned novel heating medium, also saturated water vapor and superheated steam, in one same device, as an optimal heating process for the product to be heated and the purpose of heating (Patent Document 2). The inventors had also proposed a stable control method of Aqua-gas, upon elucidation of Aqua-gas generation conditions (discovery of a critical internal pressure) (Patent Document 3).

However, these conventional technologies exhibit problems, for instance in terms of the arrangement and use of a plate heater on a device inner wall, in kitchen-type devices and large devices. That is, stable generation conditions of Aqua-gas have been realized through heating control (control of the amount of power) and control of the water supply amount, by way of the plate heater. Although such control schemes are satisfactory, the manufacture of a plate heater requires precision machining which incurs inevitable costs. As a result, there was a strong demand, in the technical field in question, for the development of a method and device for generating a heating medium that make it possible to solve reliably the problems of conventional technology, i.e. the need for precision machining and associated costs.

Patent Document 1: Japanese Patent Application Publication No. 2004-358236

Patent Document 2: Japanese Patent Application Publication No. 2007-64564

Patent Document 3: Japanese Patent Application No. 2007-260435

In the light of the above issues of conventional technology, the inventors carried out diligent research directed at developing a new technology that affords an alternatively to the plate heater in the Aqua-gas generation portion that is built into a conventional Aqua-gas heating device. As a result of that research, the inventors succeeded in developing an Aqua-gas generation system by heat exchange using electric heating and steam, and perfected thereby the present invention.

### DISCLOSURE OF THE INVENTION

An object of the present invention is to provide an Aqua-gas system that enables high-quality foodstuff heating processing with high heating efficiency. A further object of the present invention is to provide an Aqua-gas generation system by heat exchange using electric heating and steam, as an alternative to a heating system of a plate heater being an Aqua-gas generation portion built into conventional Aqua-gas heating devices. Yet a further object of the present invention is to provide a new heating medium generation system that can be used by being built into a conventional heating device, and that, in addition, can be used in a new way, as an independent Aqua-gas generation system, by introducing Aqua-gas into conventional-type food heating equipment.

The present invention for solving the above problems has the below-described constituent features.

(1) A method for generating a steam heating medium, being a method for generating, from a nozzle, Aqua-gas or low-temperature superheated steam that is a steam heating medium by operating an electrothermal-type generator or a steam-type generator, the method comprising the step of:

1) generating Aqua-gas by increasing a water supply amount in such a manner that an internal nozzle pressure takes on a constant value exceeding a saturated water vapor pressure of water at each internal nozzle pressure set temperature; or

2) generating low-temperature superheated steam by reducing the water supply amount in such a manner that the internal nozzle pressure does not exceed the saturated water vapor pressure of water at each internal nozzle pressure set temperature,

in a relational expression relating to a flow rate of water vapor sprayed from the nozzle, and given by Expression 1 or Expression 2 described later (in Expression 1, G is the water vapor flow rate, Cd is a nozzle coefficient, A2 is a nozzle outlet cross-sectional area, P1 is the internal nozzle pressure, P2 is a nozzle outlet pressure, T1 is an internal nozzle temperature, R is a gas constant of water vapor, κ is a specific heat ratio of water vapor, and P2 is atmospheric pressure in case that the water vapor jet flow from the nozzle is no faster than a speed of sound and is given by Expression 2 in the case of the speed of sound).

(2) The method for generating a steam heating medium according to (1), wherein a generation amount of high-temperature water microdroplets is controlled through continuous jetting, from a tip nozzle having a diameter of 0.1 mm or greater, of a steam heating medium that is prepared so as to satisfy, as preparation conditions of a heating medium to be jetted, 1) the water supply amount is 10 g or more per minute, 2) the internal nozzle pressure is in a pressurized state, and 3) the internal nozzle temperature is 100° C. or higher.

(3) The method for generating a steam heating medium according to (1) or (2), wherein the steam heating medium is continuously jetted into a heating chamber that is provided with a discharge path in part thereof and is in a semi-closed state, to replace air in a system.

(4) The method for generating a steam heating medium according to (1) or (2), wherein the steam heating medium is continuously jetted into a semi-closed heating chamber that is provided with a discharge path in part thereof to replace air in a system.

(5) The method for generating a steam heating medium according to any one of (1) or (2), wherein a medium of mixture of water microdroplets and superheated steam is generated.

(6) The method for generating a steam heating medium according to any one of (1) or (2), wherein superheated steam at 100° C. to 150° C. is generated.

(7) A device for generating a steam heating medium, comprising: an electric-type generator or a steam-type generator; and a tip nozzle that jets a steam heating medium, wherein a generation amount of high-temperature water microdroplets is controlled through continuous jetting, from the tip nozzle having a diameter of 0.1 mm or greater, of the steam heating medium that is prepared so as to satisfy the requirements below

1) a body to be heated, which constitutes a generation medium starting material, is water or water vapor;

2) the heat source is electricity or water vapor; and

3) as preparation conditions of a heating body to be jetted,

a) a supply amount of the starting-material body to be heated is 10 g or more per minute,

b) an internal nozzle pressure is in a pressurized state, and

c) an internal nozzle temperature is 100° C. or higher.

(8) The device for generating a steam heating medium according to (7), wherein the steam heating medium is continuously jetted into a semi-closed heating chamber that is provided with a discharge path in part thereof to replace air in a system.

(9) The device for generating a steam heating medium according to (7) or (8), wherein the steam heating medium is continuously jetted into a semi-closed heating chamber that is provided with a discharge path in part thereof to replace air in a system.

(10) The device for generating a steam heating medium according to any one of (7) or (8), wherein a medium of mixture of water microdroplets and superheated steam is generated.

The present invention is explained in further detail next.

The present invention, is a method and device for generating a steam heating medium, the method being a method for generating, from a nozzle, a steam heating medium (Aqua-gas and low-temperature superheated steam) by operating an electrothermal-type generator or a steam-type generator, the method comprising the step of 1) generating Aqua-gas by increasing a water supply amount in such a manner that an internal nozzle pressure takes on a constant value exceeding a saturated water vapor pressure of water at each internal nozzle pressure set temperature; or 2) generating low-temperature superheated steam by reducing the water supply amount in such a manner that the internal nozzle pressure does not exceed the saturated water vapor pressure of water at each internal nozzle pressure set temperature, in a relational expression relating to the flow rate of water vapor sprayed from the nozzle, and given by Expression 1 or Expression 2 described later.

In the present invention, specifically, there are developed an electrothermal-type generator and a steam-type generator as devices that rely on heat exchange by electric heating or water vapor, and Aqua-gas generation conditions are defined clearly. The present invention provides a device that is connected for a large heating machine or kitchen-type in which processing amounts and so forth of such Aqua-gas heating devices have been assumed. The present invention, moreover, delineates clearly the rate of energy savings, reduction in manufacturing costs and so forth, through measurement of the heating rate of samples, to underscore the superiority of the present invention vis-à-vis conventional-type plate heater models.

FIG. 1 and FIG. 2 illustrate the structure of an Aqua-gas generator. FIG. 3 illustrates generation conditions of Aqua-gas using these devices. In an Aqua-gas external generation device, the temperature inside an Aqua-gas jet nozzle can be set to an arbitrary temperature of 100° C. or higher. In a case where the amount of water supplied to the Aqua-gas external generation device is smaller than a given flow rate, the internal nozzle pressure that is necessary for causing all the supplied water to be sprayed from the nozzle in the form of water vapor is lower than the saturated water vapor pressure at the set temperature inside the nozzle. Therefore, all the supplied water is sprayed in the form of water vapor from the nozzle.

By contrast, in a case where the amount of water supplied to the Aqua-gas external generation device exceeds the water vapor flow rate spray from the nozzle, at the saturated water vapor pressure for the set temperature in the Aqua-gas generation nozzle, the excess fraction of the water supply amount is sprayed from the nozzle not as water vapor, but in the form of water microdroplets. In the present invention, Aqua-gas is defined as normal-pressure superheated steam that contains high-temperature water microdroplets in a state resulting from spray, from a nozzle, of water vapor and water microdroplets. Aqua-gas is generated if the internal nozzle pressure and the water supply amount lie within the region denoted by the Aqua-gas section at the top of FIG. 3.

In FIG. 3, combinations of internal nozzle pressure and water supply amount are denoted by symbols , Δ, ♦, for cases where the internal nozzle temperature is set to 110° C., 120° C. and 145° C. and instances where the water supply amount varies from 12 g to 130 g per minute. In a case where the internal nozzle pressure is lower than 1.40 MPa, 2.0 MPa or 4.0 MPa, which are the saturated water vapor pressure for each of the set temperatures, the water supply amount matches the water vapor flow rate (boundary line between Aqua-gas and superheated steam in the figure) that is determined by the internal nozzle pressure; once the internal nozzle pressure reaches the saturated water vapor pressure at the set temperature, through increase in the water supply amount, the water supply amount and the water vapor flow rate diverge thereafter, and Aqua-gas is generated as a result.

The present invention defines an Aqua-gas generator in which there are prescribed a structure and a heat exchange thermal medium such as those of FIG. 1 and FIG. 2, and defines further an Aqua-gas state (superheated steam atmosphere containing high-temperature water microdroplets) in the generator, as well as generation conditions of the Aqua-gas state.

As regards the use of the Aqua-gas generator, the latter can be used connected to conventional kitchen-type devices and large heating devices, and in addition, can also be used connected to a heating processing device of food or the like where water vapor is used as a heating medium.

Concerning device structure and so forth in relation to Aqua-gas, the inventors had already developed a method and device wherein water is boiled at high pressure, and high temperature water microdroplets and superheated steam are generated through mixing and atomization from a nozzle, as a high-quality cooking and food processing system that exploits a heating technology by superheated steam. The inventors had also developed a method and device that involved generating, other than the abovementioned heating medium, also saturated water vapor and superheated steam, in one same device, as an optimal or appropriate heating process according to the product to be heated and the purpose of heating. The inventors had further elucidated Aqua-gas generation conditions (finding relating to a critical internal pressure), and had proposed a stable control method of these conditions.

Plate heaters have been used hitherto by being disposed on the inner wall of an Aqua-gas heating device developed based on these results, in kitchen-type devices and large devices. In these devices, stable generation conditions of Aqua-gas have been realized through control of heating (control of the amount of power) and control of the water supply amount, by way of a plate heater. Although these control schemes are satisfactory, the manufacture of a plate heater requires precision machining, which incurs inevitable costs.

In the present invention there has been developed a system that allows generating Aqua-gas, in an electric heater and also through heat exchange by water vapor, as stably as in the case of a plate heater, in devices for kitchens and large heating devices. In the case of the electrothermal-type generator, savings of about 70% in manufacturing costs of these Aqua-gas generators have been achieved vis-à-vis the costs of kitchen-type devices and large devices. A comparison of the heating rate and energy consumption of the developed Aqua-gas generation device vis-à-vis those of conventional plate heaters revealed that an energy saving effect amounting to about 20% was achieved for both electrothermal- and steam-types, under conditions of identical heating rate.

A comparison of heating control between the developed Aqua-gas generation device and a conventional-type plate heater revealed that enhanced control responsiveness, among other factors, made it possible to preserve a stable Aqua-gas state, with a wide stability range. The Aqua-gas generation device can be used efficiently in accordance with a control method that involves limiting the water supply amount immediately after heating, to reach quickly an Aqua-gas state, and, thereafter, increasing the water supply amount, to ongoingly increase the heating capacity as a result.

In the present invention there has been developed a system that allows generating Aqua-gas, in an electric heater and also through heat exchange by water vapor, as stably as in the case of a plate heater, in devices for kitchens and large heating devices (FIGS. 1, 2, 4 and 6). In the case of the electrothermal-type generator, savings of about 70% in the manufacturing costs of these generators have been achieved vis-à-vis the costs of kitchen-type devices and large devices, as illustrated in FIGS. 9 and 10.

A comparison of the heating rate and energy consumption of the developed Aqua-gas generation device vis-à-vis those of conventional plate heaters revealed that an energy saving effect amounting to about 20% was achieved for both electrothermal- and steam-types, under conditions of identical heating rate, as illustrated in FIGS. 7 and 8.

It was found that the developed Aqua-gas generation device succeeded in maintaining a stable Aqua-gas state, with a wide stability range, as illustrated in FIG. 11, by virtue of better control responsiveness as compared with heating control in conventional-type plate heaters, among other factors. The Aqua-gas generation device can be used efficiently in accordance with a control method that involves limiting the water supply amount immediately after heating, to reach quickly an Aqua-gas state, and, thereafter, increasing the water supply amount, to ongoingly increase the heating capacity as a result.

The generation conditions of Aqua-gas (including low-temperature superheated steam generation conditions) involve a nozzle diameter ranging from 0.1 mm to 10 mm, preferably from 0.5 mm to 5 mm, and a water/steam supply amount of 10 g or more, preferably 10 to 1500 g, and yet more preferably 10 to 1000 g, per minute.

The internal nozzle pressure is 0.01 MPa or higher, and ranges preferably from 0.1 to 1 MPa, more preferably from 0.1 to 0.5 MPa. The internal nozzle temperature is 100° C. or higher, and ranges preferably from 100° C. to 500° C., more preferably from 100° C. to 300° C.

In the case of integration with systems in current operation, there are medium/large heating/baking devices that utilize, for instance, small/medium direct flame or far infrared heat sources, such as steam convection ovens, AQGs and the like. In the case of separate types, there are SHS (medium/large) and devices contiguous to AQG medium/large batch devices.

In an explanation of the significance of generation of low-temperature superheated steam and control thereof, low-temperature water vapor is heated at high temperature in a dedicated high-pressure apparatus “super-heater”, to prepare “superheated steam”, and the superheated steam is introduced thereafter into an open-ended heating device; in many instances, a scheme is resorted to wherein a superheated steam jet nozzle at a predetermined temperature is disposed in the vicinity of the body to be heated, with direct blowing onto the latter.

In ordinary practical heating devices, moreover, the body to be heated is moved by a belt conveyor, in a long tunnel. The temperature of the superheated steam that is used is set to a single, comparatively high temperature. Therefore, it is difficult to control finely the heating conditions in accordance with the point in time in the process, i.e. initial, intermediate and finish stages. This is one of the causes that have delayed the spread of the technology in food processing.

According to conventional tenets, generation of normal-pressure superheated steam and a stable region thereof are found at 170° C. or higher. Virtually no technical developments have been forthcoming in temperature regions at or below that temperature. However, in the wake of the sale of heating devices for domestic use and the publication of technical development results of Aqua-gas, studies have been recently undertaken on the use of superheated steam in food in a low-temperature region, at or below 170° C., also in conventional generation schemes. Nonetheless, control of the temperature and jetting time in a super-heater remain complex, and, in particular, stable operation cannot be realized in a region from 100 to 130° C.

Comparatively large equipment is habitual in the case of dedicated high-pressure equipment; also, pressure equipment regulations apply to such equipment, and hence a large-scale equipment environment has to be created as a legal requirement. Inevitably, this makes such dedicated high-pressure equipment better suited for mass production. Food processing involves high-mix low-volume products available anywhere. This is one of the reasons why conventional superheated steam is not suitable for food processing.

Streamlined and stable control of the generation of low-temperature superheated steam or Aqua-gas while affording compactness, simplicity of operation and safety under diverse conditions, can herein be realized by using the Aqua cooker of the present invention, as low-temperature superheated steam, that is useful for food processing. Regions at or below 170° C., which is the temperature region of low-temperature superheated steam, for instance regions at or below 145° C., and in particular from 100 to 115° C., were conventionally “unknown” regions for superheated steam. The inventors found that great potential for synergies between various characteristics arises through the formation of a three-in-one water vapor medium (atmosphere) of saturated water vapor/Aqua-gas/superheated steam in the vicinity of a body to be heated. As used in the present invention, the term low-temperature superheated steam denotes superheated steam at or below 170° C., in particular at or below 145° C.

In the case of Aqua-gas generation conditions with a conventional plate heater, a condition was prescribed such that, when the internal pressure exceeds a given critical pressure, the speed of the discharged water vapor becomes the limiting factor by the stage at which the speed of sound is reached, and excess hot water is discharged in the form of water microdroplets. In the present invention, however, it was found that generation of low-temperature superheated steam or Aqua-gas is possible under conditions such as those illustrated in FIG. 3, through control of the internal nozzle temperature and the amount of water vapor, under broader conditions.

In the Aqua-gas generation device, the temperature inside the Aqua-gas jet nozzle can be set to any temperature at or above 100° C. In a case where the amount of water supplied to the Aqua-gas external generation device is smaller than a given flow rate, the internal nozzle pressure necessary for causing all the supplied water to be sprayed from the nozzle in the form of water vapor is lower than the saturated water vapor pressure at the set temperature inside the nozzle. Therefore, all the supplied water is sprayed in the form of water vapor from the nozzle.

In a case where the amount of water supplied to the Aqua-gas generation device exceeds the flow rate of water vapor that is sprayed from the nozzle at the saturated water vapor pressure for the set temperature in the Aqua-gas generation nozzle, then the excess fraction of the water supply amount is sprayed from the nozzle not as water vapor, but in the form of water microdroplets. The state in which the water vapor and the water microdroplets are mixed and sprayed from the nozzle is an Aqua-gas state. Aqua-gas is generated if the internal nozzle pressure and the water supply amount lie within the region denoted by the Aqua-gas section at the top of FIG. 3.

In FIG. 3, as described above, combinations of internal nozzle pressure and water supply amount are illustrated for cases where the internal nozzle temperature is set to 110° C., 120° C. and 145° C. and the water supply amount varies from 12 g to 130 g per minute. In a case where the internal nozzle pressure is lower than 1.40 MPa, 2.0 MPa or 4.0 MPa, which are the saturated water vapor pressure for each of the set temperatures, the water supply amount matches the water vapor flow rate (boundary line between Aqua-gas and superheated steam in the figure) that is determined by the internal nozzle pressure; once the internal nozzle pressure reaches the saturated water vapor pressure at the set temperature, through increase in the water supply amount, the water supply amount and the water vapor flow rate diverge thereafter, and Aqua-gas is generated as a result.

A comparison between the heating time and energy consumption upon heating of a danshaku potato up to a core temperature of 95° C. using an electrothermal-type generator, vis-à-vis a conventional plate heater, revealed an energy saving effect of about 17%. No differences in quality between the heated danshaku potatoes were found. A comparison between the average heating time and energy consumption in heating, over a plurality of times, of M-size (82 to 98 g) danshaku potatoes to a core temperature of 95° C. using a steam-type generator, vis-à-vis a conventional plate heater, revealed an energy saving effect of about 23%, with no differences in reproducibility and quality.

In a kitchen-type Aqua cooker (model AQ-25G), the conventional plate heater (two-set) can be replaced by an electrothermal-type generator (one unit). A significant reduction in the cost of major components, of about 70%, can be thus achieved. In a large device (model AQ-200G), the above effect can be expected to amount to about 3 million yen, i.e. a cost reduction of about 68%. Dispensing with the need for the plate heater can be expected to translate also into space savings, into the possibility of switching from pure water specifications to soft water specifications, and into lower labor costs involved in the manufacture of the device.

In the present invention, the capacity of the heater can be controlled easily. As a result there can be improved the control range of Aqua-gas accompanying changes in the water supply amount. In experiments thus far, Aqua-gas generation has been found to take place with a water supply amount of up to about 30 ml/min. By virtue of the above, a quick bactericidal effect has been proved in an assessment of sterilization at the finished-product stage of dry delicacies, in that the influence on texture, taste, flavor and so forth was very small as compared with an instance of treatment using superheated steam/saturated water vapor/high-temperature air.

The present invention elicits the following effects.

(1) The Aqua cooker of the present invention can be expected to afford cost reductions in Aqua-gas heating processing, through enhancement of efficiency beyond that of conventional plate heaters. Small stand-alone generators can be used concomitantly with heating and processing machines that employ conventional steam as a heat source, and can be used as alternative heat sources. The use of the Aqua cooker of the present invention can be expected to spread in ever wider fields of applications, including the creation of new Aqua-gas technologies.

(2) Using the Aqua cooker of the present invention enables heating processing, in a simple manner and at a reasonable cost, of high-mix low-volume products in conventional processing sites (backyards, central kitchens, processing plants, galleys and the like). Improvements in the cost-performance ratio of existing products can likewise be expected through the use of the Aqua cooker of the present invention.

(3) Multiple heating can be realized, concomitantly with Aqua-gas.

(4) Upgrades are made possible through annexing to existing superheated steam systems.

(5) Convenient heating functionality can be enhanced through annexing to an existing steam convection oven.

### BRIEF DESCRIPTION OF THE DRAWINGS

FIG. 1 illustrates an electrothermal-type generator;

FIG. 2 illustrates a steam-type generator;

FIG. 3 illustrates Aqua-gas generation conditions (nozzle bore: 1.3 mm) in a steam-type generator;

FIG. 4 illustrates a kitchen-type system by an electrothermal-type generator;

FIG. 5 illustrates a kitchen-type system by a plate heater;

FIG. 6 illustrates a large device system by a panel heater;

FIG. 7 illustrates a large device system by a steam-type generator;

FIG. 8 illustrates an electrothermal-type generator annexed to an existing heating device (steam convection oven);

FIG. 9 illustrates a performance comparison between an electrothermal-type generator and a conventional plate heater;

FIG. 10 illustrates a performance comparison between a steam-type generator and a conventional plate heater; and

FIG. 11 illustrates water supply amount and heater capacity in an electrothermal-type generator.

### BEST MODE FOR CARRYING OUT THE INVENTION

The present invention will be explained next in a concrete manner based on embodiments, but the present invention is in no way meant to be limited to or by the below-described embodiments.

### Embodiment 1

In the present embodiment an electrothermal-type generator and a steam-type generator were designed and manufactured as a heating medium (Aqua-gas and low-temperature superheated steam) generation system (Aqua cooker).

(1) Electrothermal-Type Generator

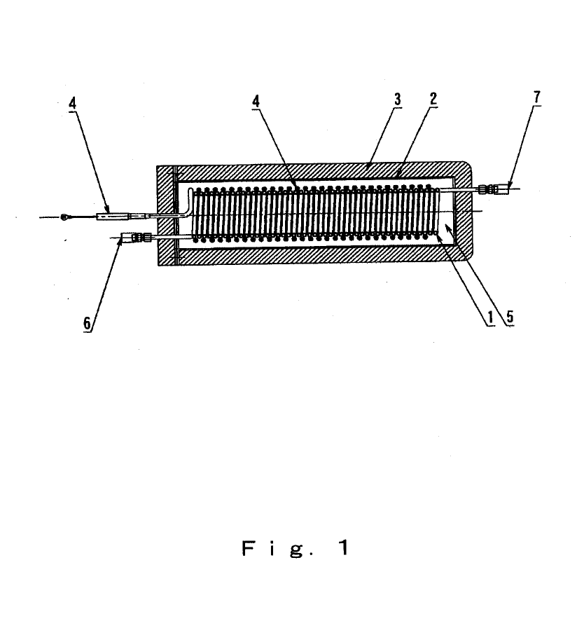

FIG. 1 illustrates schematically the structure of an electrothermal-type generator. To form the electrothermal-type generator, an electric heater 4 (220 V, 6 kw) that was formed to a coil shape was mounted, in an close-contact state, to a heat exchange pipe 1 (CuPφ6) that was likewise formed to a coil shape; the foregoing were brought into complete contact with each other by using a high heat transfer filler 5 (T-99, by Thermon Manufacturing, USA), and the whole was inserted into a heat exchange housing 2 having a heat insulating structure. In this state, water was fed to a water supply port 6 by a metering pump, and the capacity of the electric heater 4 was controlled, to check the generation of the heating medium Aqua-gas, or the generation of superheated steam (low-temperature superheated steam) by low-temperature control out of a discharge port 7.

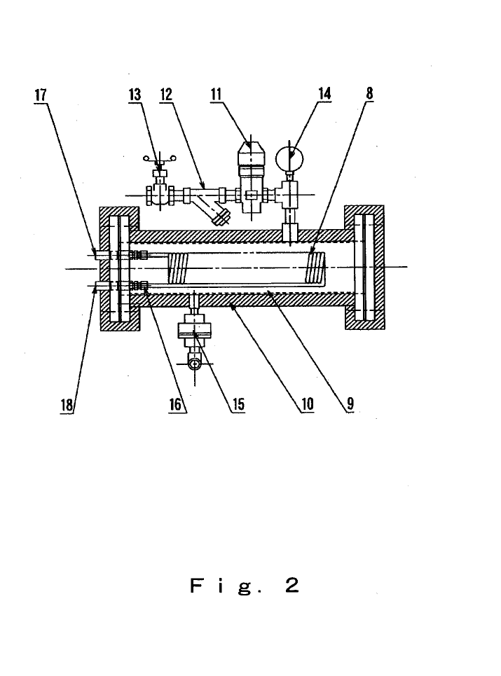

FIG. 2 illustrates schematically the structure of a steam-type generator. In the steam-type generator, a heat exchange pipe 8 (CuPφ6) formed to a coil shape was mounted to the interior of a heat exchange housing 10 having a heat insulating structure, and pressure-regulated steam was supplied via a steam pressure-reducing valve 11 connected to the heat exchange housing 10, to fill thereby the interior of the housing 10 with steam at a predetermined pressure.

In this state, water was fed to a water supply port 17 by a metering pump, and steam pressure was controlled by way of the steam pressure-reducing valve 13, thereby to check the generation of Aqua-gas or low-temperature superheated steam being the heating medium, out of a discharge port 18. In the heat exchange housing 10, heat exchange with supply water took place via the heat exchange pipe 8, and the condensed steam was discharged out, through a steam trap 15, to promote the supply of pressure-adjusted steam.

### Embodiment 2

In the present embodiment, the generation mechanism of the heating medium, as well as the characteristics of the generated heating medium, were elucidated, and generation conditions of the heating medium were set.

Water was supplied, by way of a solenoid metering pump, to the steam-type generator (FIG. 2). The operation speed of the pump was adjusted to 30 to 330 strokes/minute, and the water supply amount was measured on the basis of the change in mass in a water-storage tank. The water supply amount was 12 to 130 g/minute. A nozzle having a 1.3 mm bore was fitted to the steam-type generator, and a temperature sensor and a pressure sensor were fitted at a stagnant section of the nozzle, to measure the temperature and pressure inside the nozzle. The temperature inside the nozzle was controlled to 110° C., 120° C. and 145° C. through adjustment of the pressure of primary water vapor that was supplied from a boiler to the electrothermal-type generator. The water vapor flow rate of the water vapor that is sprayed from the nozzle during operation of the steam-type generator can be worked out on the basis of the expression below.

$$\begin{matrix}[ Expression 1 ] & \\ G = Cd \cdot {A}_{2} \frac{{P}_{1}}{\sqrt{{RT}_{1}}} {( \frac{{P}_{2}}{{P}_{1}} )}^{\frac{1}{κ}} \sqrt{2 \frac{κ}{κ - 1} \{ 1 - {( \frac{{P}_{2}}{{P}_{1}} )}^{\frac{κ - 1}{κ}} \}} & [ E1 ]\end{matrix}$$

In Expression 1, G denotes the water vapor flow rate, Cd denotes a nozzle coefficient, A2 denotes the nozzle outlet cross-sectional area, P1 denotes the internal nozzle pressure, P2 denotes the nozzle outlet pressure, T1 denotes the internal nozzle temperature, R denotes the gas constant of water vapor, and κ denotes the specific heat ratio of water vapor. When the water vapor jet flow from the nozzle is no faster than the speed of sound, P2 is atmospheric pressure and is given by the following expression when the water vapor flows at the speed of sound.

$$\begin{matrix}[ Expression 2 ] & \\ {P}_{2} = {{P}_{1} ( \frac{2}{κ + 1} )}^{\frac{κ}{κ - 1}} & [ E2 ]\end{matrix}$$

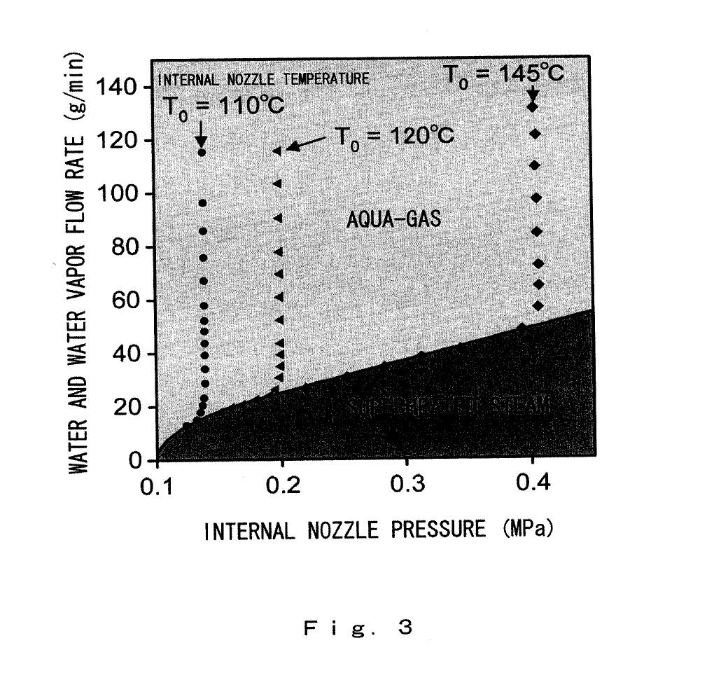

FIG. 3 illustrates the amount of water supplied to the device with respect to the measured internal nozzle pressure (MPa), i.e. the flow rate of water and water vapor sprayed from the nozzle, upon operation of the steam-type generator. The water supply amount matched the water vapor flow rate calculated based on Expression 1 (boundary line of Aqua-gas and superheated steam in the figure) in a case where the water supply amount was low, for internal nozzle temperatures Tₒ=110° C., 120° C. and 145° C. That is because all the supplied water evaporated, and only water vapor was jetted from the nozzle. Observation of the nozzle outlet revealed no water droplet generation under those conditions.

However, it was found that the internal nozzle pressure rises as the water supply amount increases, at a region of low water supply amount, for various conditions of internal nozzle temperature. By contrast, it was not observed that the internal nozzle pressure rose accompanying an increase of the water supply amount when the internal nozzle pressure reached the saturated water vapor pressure of water for each internal nozzle pressure set temperature (about 0.14 MPa at 110° C., about 0.20 MPa at 120° C., and about 0.41 MPa at 145° C.); instead, it was found that a divergence arose in the water supply amount and the water vapor flow rate obtained on the basis of Expression 1. Generation of high-temperature water microdroplets from a nozzle outlet was observed to occur at the conditions for which this divergence arose.

As an Aqua-gas generation condition, the water supply amount was increased so that the internal nozzle pressure exceeded the saturated water vapor pressure of water for each internal nozzle pressure set temperature (about 0.14 MPa at 110° C., about 0.20 MPa at 120° C. and about 0.41 MPa at 145° C.) and took on a constant value.

As a generation condition of superheated steam by low-temperature region control, the water supply amount was reduced so that the internal nozzle pressure did not exceed the saturated water vapor pressure of water for each internal nozzle pressure set temperature (about 0.14 MPa at 110° C., about 0.20 MPa at 120° C. and about 0.41 MPa at 145° C.).

### Embodiment 3

In the present embodiment a heating medium (Aqua-gas and low-temperature superheated steam) generation system (Aqua cooker) was designed and manufactured, and the basic performance of the system was evaluated.

(1) Device

1) Kitchen-Type System

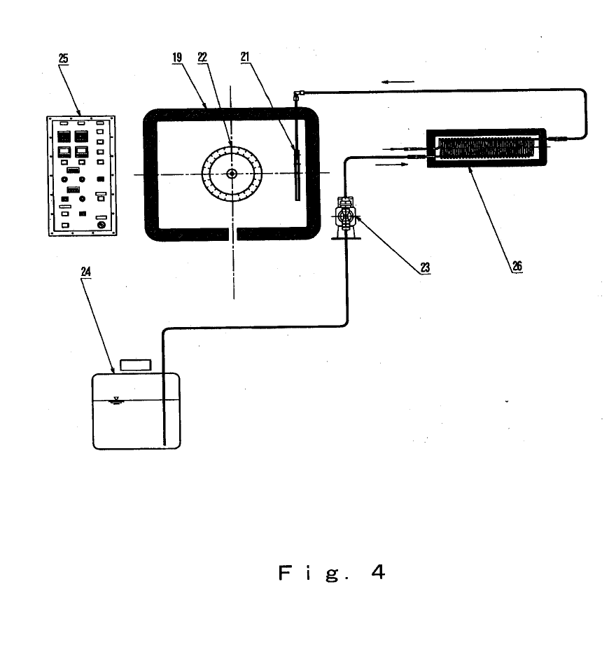

A kitchen-type system by a small steam-type generator (FIG. 2) or a fitted electrothermal-type generator (FIG. 1) was made up of: a metering pump 23 that connected a water supply tank 24 and a heating chamber 19, in a semi-closed state, being a heat insulating structure provided with a discharge path in a part thereof; a generator 26 connected to the pump; a jet nozzle header 21 connected to the generator, and a jet nozzle; operation equipment for control thereof; and an operation panel 25 (FIG. 4). A heating body held at predetermined temperature and pressure in the generator through water supply from the metering pump 23 was caused to be jetted into the heating chamber 19 through the jet nozzle, as a result of which the interior of the heating chamber became filled with low-temperature superheated steam or Aqua-gas as the heating medium.

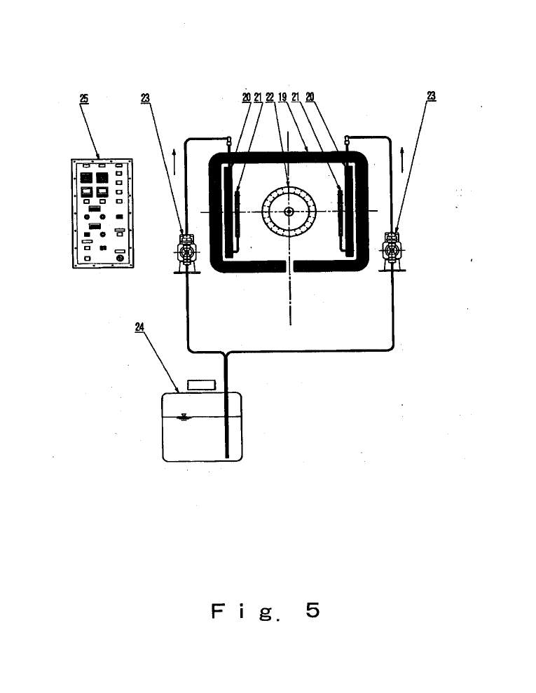

This structure is similar to that of a kitchen-type system by a conventional-type plate heater (FIG. 5; Aqua cooker RTN), but in the structure of a kitchen-type system by a conventional-type plate heater, the generator (plate heater 20) is disposed inside the heating chamber, and is used for generating Aqua-gas and, at the same time, stabilizing the heating chamber temperature; further, the generator is used as an auxiliary heater for transfer of heat to the product to be heated. The generation medium is stabilized depending on the amount of supply water, and through heat dissipation from, or absorption by, the plate surface.

In an electrothermal-type generator (FIG. 1) or small steam-type generator (FIG. 2), by contrast, generation of Aqua-gas or low-temperature superheated steam can be controlled simply and stably from outside the heating chamber; as a result, preservation of a predetermined temperature inside the heating chamber can be easily controlled by an independent auxiliary heater. It became thus possible to quickly maintain a steady state, just through introduction of a generation medium into the temperature-adjusted heating chamber. Further, the range of pressure adjustment was expanded by increasing the processing capacity of supply water in the generator, while the jet nozzle, which required a dual nozzle in a conventional plate heater scheme (Aqua cooker 20), could be made into a single nozzle. It was found that the afforded performance was similar to that of a kitchen-type system by a conventional-type plate heater.

2) Large Device System

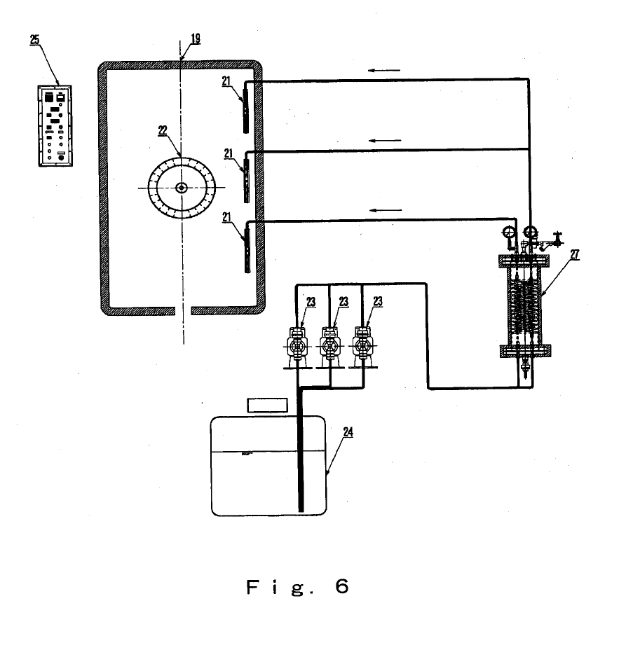

A large device system (FIG. 6) by a steam-type generator (type of FIG. 2) or a large electrothermal-type generator (type in FIG. 1) was made up of: a metering pump 23 that connected a water supply tank 24 and a heating chamber, in a semi-closed state, being a heat insulating structure provided with a discharge path in a part thereof; a generator connected to the pump; a jet nozzle header 21 connected to the generator, and a jet nozzle; operation equipment for control thereof; and an operation panel 25. A heating body held at predetermined temperature and pressure in the steam-type generator 27 through water supply from the metering pump 23 was caused to be jetted into the heating chamber through the jet nozzle, as a result of which the interior of the heating chamber became filled with low-temperature superheated steam or Aqua-gas as the heating medium.

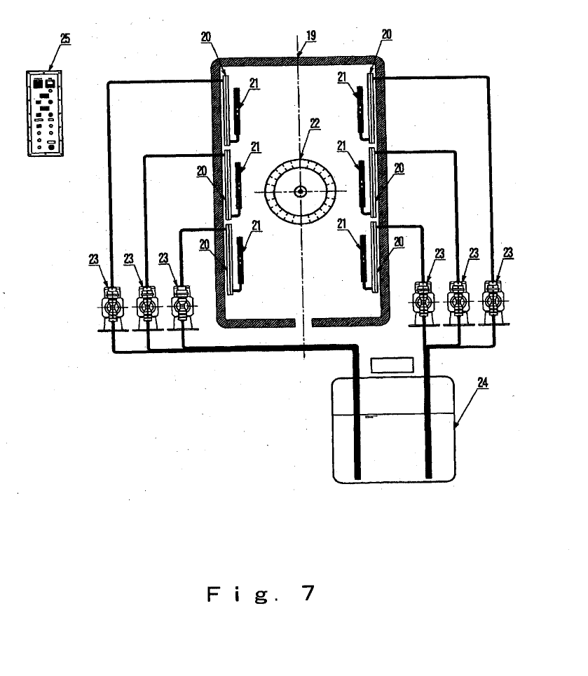

This structure is similar to that of a conventional-type plate heater system (FIG. 7; Aqua cooker RTN), but in the conventional-type plate heater system, the generator (plate heater 20) is disposed inside the heating chamber 19, and is used for generating Aqua-gas and, at the same time, stabilizing the heating chamber temperature; further, the generator is used as an auxiliary heater for transfer of heat to the product to be heated. The generation medium is stabilized depending on the amount of supply water, and through heat dissipation from, or absorption by, the plate surface.

In a steam-type generator (type of FIG. 2) or large electrothermal-type generator (type of FIG. 1), by contrast, generation of Aqua-gas or low-temperature superheated steam can be controlled simply and stably from outside the heating chamber; hence, the temperature inside the heating chamber can be easily maintained by an independent auxiliary heater. It became thus possible to quickly maintain a steady state, just through introduction of a generation medium into the temperature-adjusted heating chamber. Further, the processing capacity of supply water in the steam-type generator was increased, and the range of pressure adjustment was expanded, so that the jet nozzle, which requires a six-nozzle scheme in a conventional plate heater, could be made here into a triple nozzle.

3) Upgrade of Existing Heating Equipment of Water Vapor or the Like

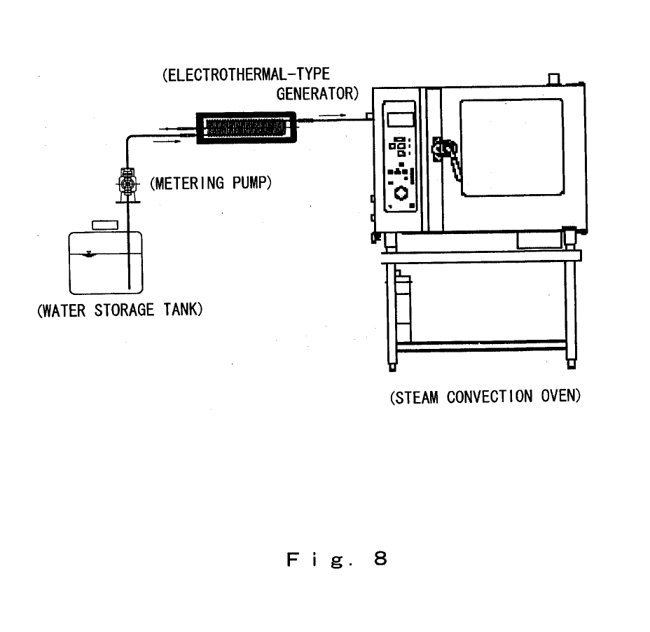

The electrothermal-type generator (FIG. 1) or the steam-type generator (FIG. 2) could be easily fitted to existing steam heating machines, steam convection ovens, steamers and the like. FIG. 8 illustrates an instance where the electrothermal-type generator is annexed to a steam convection oven. In this instance, it was possible to remodel existing equipment, in an easy manner and at a low cost, into a novel Aqua cooker supplemented with the function of generating Aqua-gas or low-temperature superheated steam. The results of generation tests conducted using the device of FIG. 8 evidenced generation of both Aqua-gas and low-temperature superheated steam.

(2) Basic Performance Measurement and Evaluation

1) Energy Saving Effect

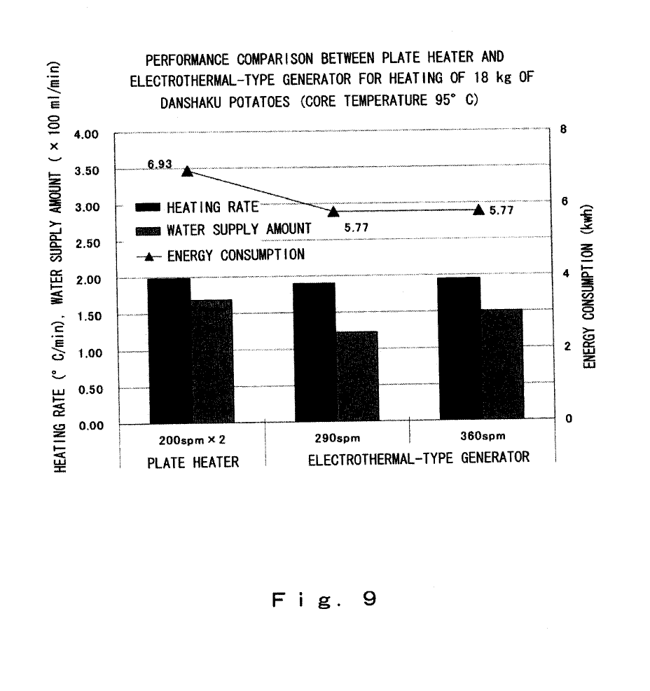

A performance comparison was performed using a device resulting from fitting an electrothermal-type generator (FIG. 1) and a conventional-type plate heater 20 (used in an Aqua cooker) to a same heating chamber 19. The quality of the product to be heated was evaluated, and water consumption and power consumption were likewise assessed (FIG. 9). Danshaku potatoes of M size (82 to 98 g) were used as the product to be heated, and were heated, in respective amounts of 18 kg, on a perforated tray, up to a core temperature of 95° C. The results showed that, in a state of substantially identical heating rate, power consumption in the conventional-type plate heater was 6.93 kwh, versus 5.77 kwh in the electrothermal-type generator (FIG. 1). Power consumption was thus reduced by about 17%. No differences were appreciated as regards the taste and texture of the heated danshaku potatoes.

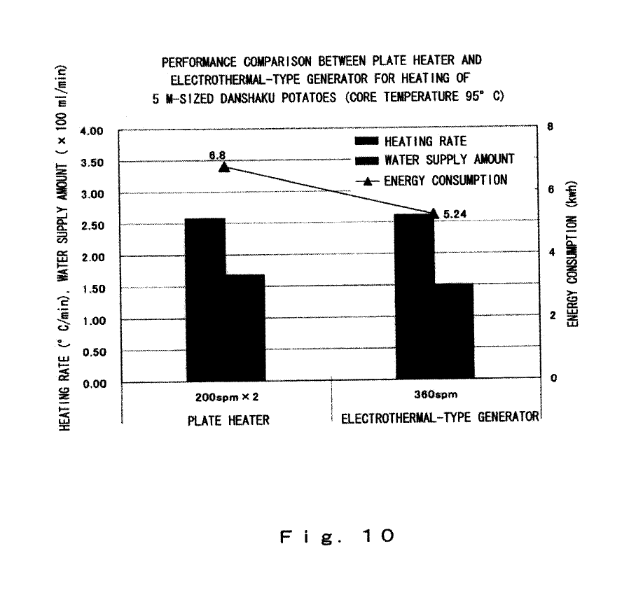

The above assessment was performed in the same way (FIG. 10) using now a steam-type generator (FIG. 2) and a conventional-type plate heater 20 (used in an Aqua cooker). As the product to be heated, five danshaku potatoes of M size (82 to 98 g) were heated up to a core temperature of 95° C. The results showed that, in a state of substantially identical heating rate, power consumption in the conventional-type plate heater was 6.8 kwh, versus 5.24 kwh in the steam-type generator, i.e. a reduction of about 23% was achieved. No differences were appreciated as regards the taste and texture of the heated danshaku potatoes. The above results indicate that the electrothermal-type generator (FIG. 1) and the steam-type generator (FIG. 2) elicit a high energy saving effect as compared with a conventional-type panel heater scheme (used in an Aqua cooker).

2) Effects on Labor Savings in the Manufacture of the Device, Resource Conservation, and Operation Streamlining

i) Labor Savings and Resource Conservation by Dispensing with Precision Metal-Cutting Processes

In a conventional-type plate heater (used in an Aqua cooker), grooves in the form of hairpins had to be cut in plate stock by precision machining. Also, the surface had to be treated with an anti-corrosion coating. Cost reductions were difficult to achieve on account of the increased processing costs incurred in shaping of the electric heater and the heat exchange pipe to a shape matching that of the hairpin-like grooves. It was found that in the electrothermal-type generator and the steam-type generator, it is sufficient to work the heat exchange pipes and the electric heater into a coil shape, and labor can be saved as regards precision machining of plate stock, and shape processing of the heat exchange pipe and the electric heater.

ii) Streamlining Through Switching from High-Purity Supply Water to Soft Water

In a conventional-type plate heater (used in an Aqua cooker), heat exchange pipes are shaped as hairpins. Therefore, supply water had to be subjected to a reverse-osmosis membrane treatment in order to prevent scale adhesion that arises from local pressure losses in the heat exchange pipes. The heat exchange pipes in the electrothermal-type generator and the steam-type generator are coil-shaped. Therefore, occurrence of local losses was prevented, and, as a result, the electrothermal-type generator and the steam-type generator coped successfully with processing using soft water. The difference in cost between reverse-osmosis membrane processing and soft water processing was considerable. A significant improvement in maintenance was achieved at the same time.

iii) Contribution of Enhanced Medium Controllability and Greater Control Range to Operation Streamlining

In the electrothermal-type generator (FIG. 1) and the steam-type generator (FIG. 2) no quantity of heat was used other than for generation of Aqua-gas or low-temperature superheated steam. Therefore, it was found that Aqua-gas or low-temperature superheated steam could be generated stably simply through control of the quantity of heat in the electric heater and the primary supply steam, also upon supply of a low water amount.

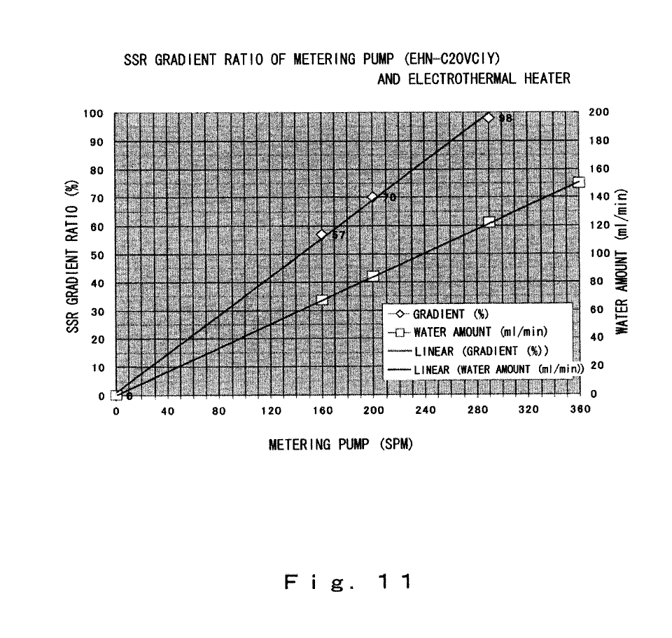

FIG. 11 is a graph illustrating the relationship between water supply amount and the electric heater in an electrothermal-type generator. The control range was expanded in that control was also possible at a region where, in conventional-type plate heaters, control is rendered unstable by the influence of the quantity of heat in the heating chamber. For instance, control at about 80 spm (35 ml/min) was also possible. Generation characteristics (Aqua-gas characteristics) of water microdroplets from a jet nozzle under these conditions were also observed.

3) Device Downsizing

It was possible to downsize the entire device as a result of reduction in the size of the heating chamber, derived from an increased effective internal volume, and as a result of savings in space in the water treatment portion, through streamlining brought about by switching from high-purity supply water to soft water. Such downsizing enables the use of the device in hospital kitchens and restaurant kitchens, where a smaller device is desirable on account of kitchen space problems.

4) Cost-Performance Ratio of a Novel Heating Device (Aqua Cooker) Equipped with a Heating Medium Generation System

(1) Cost Reduction Effect of Novel Aqua Cooker

As compared with a conventional-type plate heater scheme (Aqua cooker), the plate stock, as a constituent component of the plate heater, becomes now unnecessary, and cost reductions can be achieved as regards precision machining and processing costs in shape processing of the heat exchange pipe and the electric heater. It was found thus that costs could be significantly cut in major constituent components. This can prove instrumental in lowering the greatest barrier to the practical use of the Aqua cooker.

(2) Performance Measurement and Evaluation of the Aqua Cooker

The Aqua cooker could be controlled with a low amount of water supply. Therefore, it was possible to realize low-invasive, fast sterilization of dried food or the like, for which moist heat sterilization is not possible in conventional techniques. As an example, dried food (dried salmon strips) having salmon as a starting material were sterilized. The bacterial count results are given in Table 1, and the sensory evaluation results are given in Table 2. As these tables show, the bacterial count results were negative for coliform count, with a total viable count of 300 or less, in the Aqua-gas processed product. The sensory evaluation results revealed no changes in color or appearance, and little changes in taste and texture, as compared with unprocessed product. This clearly underscored the singularity of the novel Aqua cooker.

TABLE 1

| Inspection item | Total viable count | Coliform count |
|---|---|---|
| Unprocessed product | 5.5 × 10⁴ | 20 |
| Aqua-gas processed product A | 300 or less | Negative |
| (115° C., 15 sec) | | |
| Aqua-gas processed product B | 300 or less | Negative |
| (115° C., 20 sec) | | |

TABLE 2

| Processing method | Sensory evaluation |
|---|---|
| Aqua-gas | No change in color or appearance, and little |
| processing | change in taste and texture, as compared |
| | with unprocessed product |
| Superheated steam | Charred-surface discoloration, poor cooked |
| processing | taste, hard texture, unfit for product |
| Saturated water | Covered with moisture, no dried state, bland |
| vapor processing | taste, texture not that of a dried product |

(3) Evaluation of the Cost-Performance Ratio of the Aqua Cooker

The above-described considerable cost reductions and performance enhancement thus achieved are significantly useful for the Aqua cooker business, and can contribute to improving both the quality and quantity of people's diet accompanying a fast spread of the Aqua cooker.

### INDUSTRIAL APPLICABILITY

As explained in detail above, the present invention relates to a method and device for generating a heating medium. The present invention allows enhancing energy efficiency vis-à-vis a conventional plate heater. Costs in Aqua-gas heating processing can be potentially reduced as a result. Small stand-alone generators can be used concomitantly with heating and processing machines that employ conventional steam as a heat source, and can be used as alternative heat sources. The present invention is useful in terms of providing a novel technology and novel product relating to Aqua-gas, that can spur the spread in the adoption of Aqua-gas, in ever wider fields of applications, including the creation of novel Aqua-gas technologies.

### EXPLANATION OF REFERENCE NUMERALS

1 heat exchange pipe
2 heat exchange housing
3 heat insulating material
4 electric heater
5 high heat transfer filler
6 water supply port
7 discharge port
8 heat exchange pipe
9 heat exchange housing
10 heat insulating material
11 steam pressure-reducing valve
12 steam strainer
13 steam supply valve
14 pressure gauge
15 steam trap
16 fitting
17 water supply port
18 discharge port
19 heating chamber
20 plate heater
21 nozzle header
22 agitation blower
23 metering pump
24 water supply tank
25 operation panel
26 electrothermal-type generator
27 steam-type generator

1. A method for generating a steam heating medium, being a method for generating, from a nozzle, Aqua-gas or low-temperature superheated steam that is a steam heating medium by operating an electrothermal-type generator or a steam-type generator, the method comprising the step of:
1) generating Aqua-gas by increasing a water supply amount in such a manner that an internal nozzle pressure takes on a constant value exceeding a saturated water vapor pressure of water at each internal nozzle pressure set temperature; or
2) generating low-temperature superheated steam by reducing the water supply amount in such a manner that the internal nozzle pressure does not exceed the saturated water vapor pressure of water at each internal nozzle pressure set temperature,
in a relational expression relating to a flow rate of water vapor sprayed from the nozzle, and given by Expression 1 or Expression 2 below (in Expression 1, G is the water vapor flow rate, Cd is a nozzle coefficient, A2 is a nozzle outlet cross-sectional area, P1 is the internal nozzle pressure, P2 is a nozzle outlet pressure, T1 is an internal nozzle temperature, R is a gas constant of water vapor, κ is a specific heat ratio of water vapor, and P2 is atmospheric pressure in case that a water vapor jet flow from the nozzle is no faster than a speed of sound and is given by Expression 2 in the case of the speed of sound).
$$\begin{matrix}[ Expression 1 ] & \\ G = Cd \cdot {A}_{2} \frac{{P}_{1}}{\sqrt{{RT}_{1}}} {( \frac{{P}_{2}}{{P}_{1}} )}^{\frac{1}{κ}} \sqrt{2 \frac{κ}{κ - 1} \{ 1 - {( \frac{{P}_{2}}{{P}_{1}} )}^{\frac{κ - 1}{κ}} \}} & [ E1 ] \\ [ Expression 2 ] & \\ {P}_{2} = {{P}_{1} ( \frac{2}{κ + 1} )}^{\frac{κ}{κ - 1}} & [ E2 ]\end{matrix}$$

2. The method for generating a steam heating medium according to claim 1, wherein a generation amount of high-temperature water microdroplets is controlled through continuous jetting, from a tip nozzle having a diameter of 0.1 mm or greater, of a steam heating medium that is prepared so as to satisfy, as preparation conditions of a heating medium to be jetted, 1) the water supply amount is 10 g or more per minute, 2) the internal nozzle pressure is in a pressurized state, and 3) the internal nozzle temperature is 100° C. or higher.

3. The method for generating a steam heating medium according to claim 1 or 2, wherein the steam heating medium is continuously jetted into a heating chamber that is provided with a discharge path in part thereof and is in a semi-closed state, to replace air in a system.

4. The method for generating a steam heating medium according to claim 1 or 2, wherein the steam heating medium is continuously jetted into a semi-closed heating chamber that is provided with a discharge path in part thereof to replace air in a system.

5. The method for generating a steam heating medium according to any one of claim 1 or 2, wherein a medium of mixture of water microdroplets and superheated steam is generated.

6. The method for generating a steam heating medium according to any one of claim 1 or 2, wherein superheated steam at 100° C. to 150° C. is generated.

7. A device for generating a steam heating medium, comprising: an electric-type generator or a steam-type generator; and a tip nozzle that jets a steam heating medium,
wherein a generation amount of high-temperature water microdroplets is controlled through continuous jetting, from the tip nozzle having a diameter of 0.1 mm or greater, of the steam heating medium that is prepared so as to satisfy the requirements below
1) a body to be heated, which constitutes a generation medium starting material, is water or water vapor;
2) the heat source is electricity or water vapor; and
3) as preparation conditions of a heating body to be jetted,
a) a supply amount of the starting-material body to be heated is 10 g or more per minute,
b) an internal nozzle pressure is in a pressurized state, and
c) an internal nozzle temperature is 100° C. or higher.

8. The device for generating a steam heating medium according to claim 7, wherein the steam heating medium is continuously jetted into a semi-closed heating chamber that is provided with a discharge path in part thereof to replace air in a system.

9. The device for generating a steam heating medium according to claim 7 or 8, wherein the steam heating medium is continuously jetted into a semi-closed heating chamber that is provided with a discharge path in part thereof to replace air in a system.

10. The device for generating a steam heating medium according to any one of claim 7 or 8, wherein a medium of mixture of water microdroplets and superheated steam is generated.
